(19) United States
(12) Patent Application Publication
(10) Pub. No.: US 2005/0221875 A1
(43) Pub. Date: Oct. 6, 2005

(54) Wireless subscriber communication unit and antenna arrangement therefor

(76) Inventors: Ovadia Grossman, Tel Aviv (IL); Moshe Ben-Ayun, Shoham (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/139,138

(22) Filed: May 28, 2005

(30) Foreign Application Priority Data
Nov. 29, 2002 (GB) GB 0227929.7

(51) Int. Cl. H04B 1/44

(52) U.S. Cl. 455/575.7; 455/562.1; 455/78

(57) ABSTRACT

A wireless subscriber communication unit (200) comprises an antenna arrangement (202, 330, 430) for radiating and/or receiving electromagnetic signals. A transmitter (220) and/or a receiver (210) is/are operably coupled to the antenna arrangement (202, 330, 430), for transmitting/receiving a radio signal. An antenna arrangement comprises an internal antenna located within the wireless communication unit (200) and an external antenna located substantially outside of the wireless communication unit, such that both the internal antenna (330, 430) and the external antenna (202) co-operate on substantially the same electromagnetic signal. In this manner, by provision of both an internal and an external antenna the wireless subscriber communication unit is able to function adequately should an antenna become disconnected, malfunction, or its performance suffer from impedance mismatching. Preferably, the internal and external antennas can be configured to be orthogonal to one another, thereby providing the wireless subscriber unit with the ability to operate with a substantially circular or elliptical polarization.

### FIELD OF THE INVENTION

This invention relates to a wireless subscriber communication unit and antenna arrangement therefor. The invention is applicable to, but not limited to, a radio frequency arrangement providing two (or more) antennas that improve antenna performance of a wireless subscriber communication unit as well as increase return power isolation between the antennas and a radio transmitter therein.

### BACKGROUND OF THE INVENTION

Wireless communication systems, for example cellular telephony or private mobile radio communication systems, typically provide for radio telecommunication links to be arranged between a plurality of base transceiver stations (BTSs) and a plurality of subscriber units, often termed mobile stations (MSs). The term mobile station generally includes both hand-portable and vehicular mounted radio units. Radio frequency (RF) transmitters are located in both BTSs and MSs in order to facilitate wireless communication between the communication units.

In the field of this invention, it is known that continuing pressure on the limited radio spectrum available for radio communication systems is focusing attention on the development of spectrally efficient linear modulation schemes. By using spectrally efficient linear modulation schemes, more communication units are able to share the allocated spectrum within a defined coverage area (communication cell). An example of a digital mobile radio system that uses a linear modulation method, such as π/4 digital quaternary phase shift keying (DQPSK), is the TErrestrial Trunked RAdio (TETRA) system, developed by the European Telecommunications Standards Institute (ETSI).

Since the envelopes of these linear modulation schemes fluctuate, intermodulation products can be generated in the non-linear power amplifier. Specifically in the digital mobile radio (PMR) environment, restrictions on out-of-band emissions are severe (to the order of −60 dBc to −70 dBc). Hence, linear modulation schemes used in this scenario require highly linear transmitters.

The emphasis in portable PMR equipment is to increase battery life. Hence, it is imperative to maximise the operating efficiencies of the amplifiers used. To achieve both linearity and efficiency, so called linearisation techniques are used to improve the linearity of the more efficient amplifier classes of amplifier, for example class AB, B or C amplifiers. One such linearisation technique, often used in designing linear transmitters, is Cartesian Feedback. This is a “closed loop” negative feedback technique, which ′sums′ the baseband feedback signal in its digital “I” and “Q” formats with the corresponding “I” and “Q” input signals in the forward path. This ′closed loop′ I-Q combination is performed prior to amplifying and up-converting this signal to its required output frequency and power level. The linearising of the power amplifier requires the accurate setting of the phase and amplitude of a feedback signal.

Thus, a key aspect of linear transmitter designs is to accurately match the impedance of a wireless subscriber communication unit frequency (RF) circuits and components, particularly the antenna port, to ensure maximum energy transfer. If an impedance mismatch occurs, a maximum amount of energy is not transferred and some energy is reflected. Energy reflected back into the linearised transmitter circuit affects the level and phase of the signals in the feedback loop causing the transmitter to become unstable.

In FIG. 1, a known simplified wireless subscriber communication unit 100 is shown. The simplified wireless subscriber communication unit 100 includes a Cartesian Feedback transmitter circuit having a lineariser 122, an up-converter and power amplifier 124, a feedback path 140, and a down-converter 132. The feedback path 140 is arranged by sampling the power amplifier output signal, for example, by use of a directional coupler 142. Connected to the output of the power amplifier 124 is a circulator or isolator 126, which, in turn, is connected to an antenna switch 104.

The antenna switch 104 is connected to an antenna 102 and a receiver chain 110. Controller 114 controls the operation of the antenna switch. In this manner, the antenna switch routes radio frequency signals to the antenna from the transmitter when in a transmitting mode, and from the antenna to the receiver chain 110 when in a receiver mode. A microprocessor 128 controls the lineariser 122 and down-converter 132 to set the phase shift and attenuation to be applied to the feedback loop.

Details of the operation of such a lineariser is described in the paper “Transmitter Linearisation using Cartesian Feedback for Linear TDMA Modulation” by M. Johansson and T. Mattsson 1991 IEEE.

The lineariser circuit optimises the performance of the transmitter according to any desired specification, for example to comply with linearity or output power specifications of the communication system or to optimise the operating efficiency of the transmitter power amplifier. Operational parameters of the transmitter are adjusted to optimise the transmitter performance and include as an example, one or more of the following: amplifier bias voltage level, input power level, phase shift of the signal around the feedback loop. Such adjustments are performed by, say, the microprocessor 128. Digitally modulated ′I′ and ′Q′ signals are input to the lineariser and eventually output as a RF signal by the power amplifier 124. A real-time Cartesian feedback loop, via the feedback path 140 and the down-converter 132, ensures a linearised output signal is fed to the antenna 102.

Due to the sensitivity of such transmitter circuits, a range of control/adjustment circuits and/or components are needed so that a linear and stable output signal can be achieved under all operating circumstances. For example, the isolator (or circulator) 126 is an essential element to prevent any high power reflections from the antenna 102, say due to any antenna mismatch, from returning to the output port of the power amplifier 124. Such reflections are known to cause damage to the power amplifier. In particular, for linearised transmitter circuits, reflected signals entering the feedback path affect the phase and linearity of the feedback loop, which would typically cause the transmitter to be ′unstable′.

The isolator 126 is typically a three-port nonlinear device that provides up to 10 dB of isolation for the power amplifier 124. The isolator uses a ferrite permanent magnet to ensure that the energy is circulated, i.e. power entering from port-1 goes to port-2, from port-2 to port-3 and port-3 to port-1. Hence, a matched (50-ohm) load 144 coupled to port-3 ensures that reflected power from a de-tuned antenna 102 is routed to the load 144 and is not returned to the power amplifier 124. Such an isolator device for a UHF (400 MHz) communication unit requires a printed circuit board footprint of 6mm*6mm and costs around US$6.

Antenna mismatches may be caused by any number of events, for example, when the antenna is placed near an object such as a human head, the radiation pattern is affected. This causes the antenna input impedance to change and the antenna to operate less efficiently, radiate less, and exhibit mismatch characteristics. The isolator 124 is therefore a key component to protect the power amplifier 124 from such events. The standard approach for achieving the necessary isolation is to use a high-cost ferrite non-isotropic element, such as an isolator or circulator.

Alternatively, or in addition, a lossy element may be introduced in the transmit path between the output of the power amplifier 124 and the antenna. Although any loss introduced in this path attenuates reflected signals, thereby increasing protection to the power amplifier, the loss also affects the transmitted signal. In this manner, the power amplifier needs to transmit at an increased power level to counteract the loss. The power amplifier 124 therefore operates inefficiently, or the radio communication unit loses coverage range as it transmits at a lower power level. Hence, this solution is impractical for subscriber units

Also, in the field of wireless communication units, it is known that portable devices, as a rule, operate with only one polarization. Furthermore, the portable devices typically operate in systems with base transceiver stations having only one linear polarization system, usually vertical polarization base transceiver station antennas.

A recent development in wireless communications has been the appreciation that many portable devices are used in different spatial positions, as dictated by how the user operates the device. In this regard, alignment with the antenna polarization of the base transceiver station is only statistical. To improve system range, and/or reliability, some base transceiver stations have been enhanced with dual polarization antennas. In this way, the base transceiver station is able to better receive portable transmissions that are made from a non-ideal spatial orientation of the portable device. Dual polarization antennas are usually implemented by replicating/doubling the base transceiver station system equipment.

Such a solution has little impact on the design of the base transceiver station, as cost and size considerations are typically minimal. However, providing dual polarization antennas in portable devices is rarely, if ever, considered, as cost and size considerations are paramount in the portable design.

The inventors of the present invention have recognized an, as yet, unfulfilled need to build a portable device with a substantially circular polarization antenna. This will allow the portable device to communicate in all spatial positions such that the alignment of polarization is unnecessary. This is equivalent to a dual-polarization antenna arrangement in a base transceiver station and can greatly reduce overall system costs.

The inventors have appreciated a further incentive for portable devices to include circular polarization antenna designs. The trend in portable communication devices is for the devices to be, effectively, small portable computers with features like large screens, cameras and bar code readers, including GPS and Bluetooth™ capabilities. In this regard, the devices will be used and held in all imaginable positions- as opposed to phones and two-way radios, that when used are held in a very particular and defined way.

Furthermore, the inventors have appreciated that a portable device capable of circular polarization would provide significant benefit to TETRA private systems where there are a small number of portable devices compared to a large investment in infrastructure.

Thus, there currently exists a need to provide an improved transmitter circuit arrangement, particularly an improved antenna design and/or improved isolation circuitry; wherein the abovementioned disadvantages may be alleviated.

### STATEMENT OF INVENTION

In accordance with a first aspect of the present invention, there is provided a wireless subscriber communication unit. The wireless subscriber communication unit comprises an antenna arrangement for radiating and/or receiving electromagnetic signals. A transmitter and/or a receiver is/are operably coupled to the antenna arrangement, for transmitting/receiving a radio signal. An antenna arrangement comprises a first antenna, e.g. an internal antenna located within a body of the wireless communication unit, and a second antenna, e.g. an external antenna located substantially outside a body of the wireless communication unit. A directional coupler is operably coupled to the first antenna to route a first portion of a signal to and/or from the first antenna via a first communication path and is operably coupled to the second antenna to route a second portion of the signal to and/or from the second antenna via a second communication path. Both the first antenna and the second antenna may thereby co-operate on substantially the same electromagnetic signal. The first and second antennas are configured to produce a combined desired transmitted or received signal polarisation, which may be a linear polarisation or, in different embodiments, an elliptical or circular polarisation.

In this manner, by provision of both a first and a second antenna, the wireless subscriber communication unit in at least one embodiment is able to function adequately, should either antenna become disconnected, malfunction, or its performance suffer from impedance mismatching. A radio frequency integrated circuit may conveniently be provided to embody components of the invention. The radio frequency integrated circuit comprises an antenna arrangement for radiating and /or receiving electromagnetic signals. The antenna arrangement comprises an internal antenna located within the radio frequency integrated circuit and an output port, operably coupled to the internal antenna. The output port outputs a radio frequency signal to an external antenna located substantially outside of said radio frequency integrated circuit, such that both the internal antenna and the external antenna are able to co-operate on radiating or receiving substantially the same electromagnetic signal provided by or to the radio frequency integrated circuit.

In this manner, by provision of an internal antenna and an output port for coupling to an external antenna the radio frequency integrated circuit ensures that electromagnetic signals are radiated or received adequately, should an antenna become disconnected, malfunction, or its performance suffer from impedance mismatching.

The internal and external antennas can be configured to radiate or receive signal linear polarisations which are orthogonal to one another, thereby providing the wireless subscriber unit/ radio frequency integrated circuit with the ability to operate with a substantially circular or elliptical polarisation when the first and second signal components are suitably 90 degrees out of phase. A further antenna, e.g. a further internal antenna, may be used to receive signals reflected back from either the external or first internal antenna. In this manner, any energy resulting from antenna mismatch or disconnection or malfunction is not wasted but reused by the further internal antenna.

Further features of the invention are defined in the dependent accompanying claims.

### BRIEF DESCRIPTION OF THE DRAWINGS

FIG. 1 shows a block diagram of a known linear transmitter arrangement.

Exemplary embodiments of the present invention will now be described, with reference to the accompanying drawings, in which:

FIG. 2 illustrates a block diagram of a wireless communication unit adapted to support the various inventive concepts of a preferred embodiment of the present invention;

FIG. 3 illustrates a block diagram of a transmitter circuit adapted to support the various inventive concepts of a preferred embodiment of the present invention;

FIG. 4 illustrates a block diagram of a transmitter circuit adapted to support the various inventive concepts of an alternative embodiment of the present invention; and

FIG. 5 illustrates a cross-sectional view of an internal antenna arrangement capable of use in the preferred and alternative embodiments of the present invention.

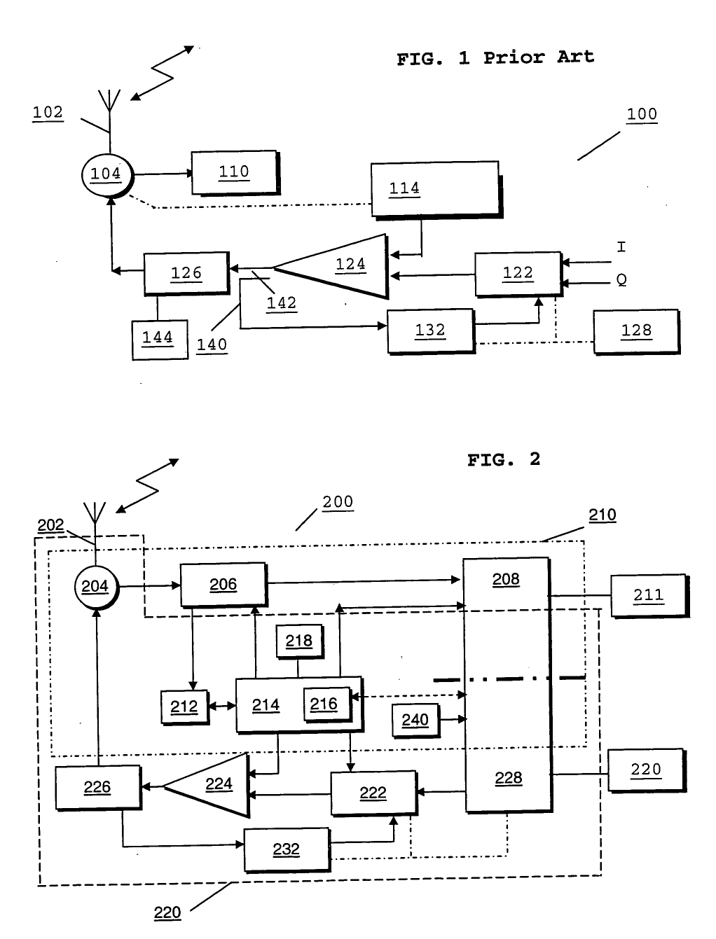

### DESCRIPTION OF PREFERRED EMBODIMENTS

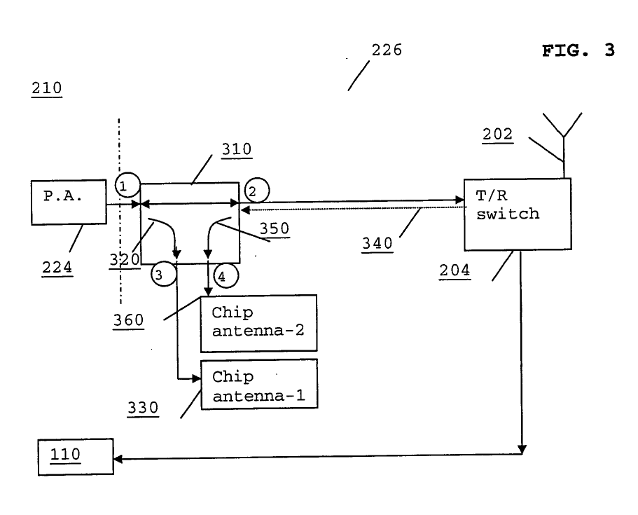

Referring now to FIG. 2, a block diagram of a wireless communication unit 200 adapted to support the inventive concepts of the preferred embodiments of the present invention, is illustrated. For the sake of clarity, the wireless communication unit 200 is shown as divided into two distinct portions — a receiver portion 210 and a transmitter portion 220.

The wireless communication unit 200 contains an antenna 202 preferably coupled to an antenna switch 204 that provides signal control of radio frequency (RF) signals in the wireless communication unit 200. The antenna switch 204 also provides isolation between the receiver 210 and transmitter chain 220. Clearly, the antenna switch 204 could be replaced with a duplex filter, for frequency duplex communication units as known to those skilled in the art.

For completeness, the receiver 210 of the wireless communication unit 200 will be briefly described. The receiver 210 includes a receiver front-end circuitry 206 (effectively providing reception, filtering and intermediate or base-band frequency conversion). The front-end circuit 206 is serially coupled to a signal processing function (generally realised by at least one digital signal processor (DSP)) 208. A controller 214 is operably coupled to the front-end circuitry 206 and a received signal strength indication (RSSI) function 212 so that the receiver is able to calculate a receiver bit-error-rate (BER), or frame-error-rate (FER), or similar link-quality measurement data from recovered information. The RSSI function 212 is operably coupled to the front-end circuitry 206. The memory device 216 stores a wide array of data, such as decoding/encoding functions and the like, as well as amplitude and phase settings to ensure a linear and stable output.

A timer 218 is operably coupled to the controller 214 to control the timing of operations, namely the transmission or reception of time-dependent signals.

As regards the transmit chain 220, this essentially includes a processor 228, lineariser circuitry (including transmitter/ modulation circuitry) 222 and an up-converter /power amplifier 224. The processor 228, lineariser circuitry 222 and the up-converter/power amplifier 224 are operationally responsive to the controller 214, with an output from the power amplifier 224 coupled to the antenna switch 204 via isolation circuitry 226.

In accordance with a preferred embodiment of the invention, improved isolation circuitry 226 has been provided. Advantageously, the isolation circuitry 226 is a less costly arrangement to isolate the power amplifier from receiving reflected, high power signals from the antenna 202. In particular, the isolation circuit 226 includes a directional coupler of the hybrid type or, a magic-T device, to provide signals to/from a second antenna. In effect, it is a four-port device with port-1 being used as an input port. Port-1 is operably coupled to port-2 (for reverse power) and port-3 for the primary transmission path. When the power amplifier power is input to port-1, a first portion of the power amplifier output signal is fed to port-2 and a second portion of the power amplifier output signal is fed to port-3. The portion amounts are dictated by the coupling factor of the device, as known in the art.

The inventors of the present invention have appreciated the benefits that can be gained from using a Magic T device, which in its basic form provides only limited isolation to the power amplifier. The earlier power amplifier linearisation schemes required full isolation to perform properly. Thus, circulators were used. With the recent development of improved linearisation algorithms, the algorithms are able to compensate for most of the antenna impedance variation. Thus, the inventors have appreciated that a reduced isolation performance is required, and that such a performance can be provided by the present scheme.

In addition recent improvements in power amplifier designs have also yielded reduced isolation requirements to ensure stability (i.e. avoidance of self-oscillations). The transmitter configuration of the preferred embodiment of the present invention is used to provide the isolation, instead of introducing passive loss before the antenna.

In the preferred embodiment of a linear transmitter circuit, the isolation circuitry 226 is operably coupled to a feedback circuit that includes a down-converter 232, which forms together with the lineariser circuitry 222 a real-time Cartesian feedback loop to ensure a linear, stable transmitter output. In accordance with the preferred embodiment of the present invention, the isolation circuitry 226 has been adapted to provide a dual-antenna (or even three antenna) arrangement. The dual-antenna arrangement is configured to provide circular or elliptical polarization to the wireless communication unit. Furthermore, the isolation circuitry 226 provides the buffering of reflected signals from antenna mismatches to the power amplifier 224.

Referring now to FIG. 3, a block diagram of an improved isolation circuit 226 of a wireless transmitter is illustrated. The transmitter circuit of the preferred embodiment of the present invention includes an isolation circuit 226 having only a few low cost components located between the power amplifier circuit 224 and the antenna 202. The output from the power amplifier circuit 224 is input to a directional coupler 310. The directional coupler 310 coupling value is determined by the required transmit isolation. The coupling is generally about half the required isolation. Such directional couplers are readily available.

In accordance with the preferred embodiment of the present invention, the directional coupler provides a secondary transmission path to a second antenna. The second antenna is preferably an internal chip antenna, indicated as chip antenna-1 330 that is used to radiate a sampled portion of the signal on the main forward transmission path. The magic-T directional coupler 310, in the preferred embodiment of the present invention, is configured to provide a dual transmission path to two antennas 202, 330, whilst increasing the isolation of the power amplifier 224 from reflections from the antenna 202.

In this manner, the isolation circuit 226 provides power amplifier isolation from any antenna impedance variations. Advantageously, the actual magnitude of isolation/protection provided to the power amplifier may be defined by selecting an appropriate coupling value of the directional coupler.

In practice, the best example is a 10-db coupler, where the energy forwarded to the external antenna 202 is reduced by approximately 0.5 db due to insertion loss of the directional coupler device 310. Instead of this portion of the transmit signal being lost (dissipated), the portion of the transmit signal is redirected into the small internal chip antenna-1 330.

In an enhanced embodiment of the present invention, the internal antenna 330 is configured preferably to be orthogonal to the (main) external antenna 202. The antenna suitable for this radiation is a small internal chip antenna, that provides some form of polarization divergence, or resulting in an elliptical polarization. In particular, the phase centers of the two antennas are configured to be close together, which is usually the case. Alternatively, the internal antenna 330 may be configured to be in phase with the (main) external antenna 202, such that it can be used to enhance the radiated or received electromagnetic signals in the same polarization. This arrangement is preferred when, say, the BTS transmits a dual-polarization signal and where an elliptical or circular polarized antenna at the subscriber unit would therefore provide less improvement.

When the internal antenna 330 is configured to be in phase with the external antenna 202, the radiated signal to/from the internal antenna enhances that of the external antenna. If the internal antenna 330 is configured to be orthogonal to the external antenna 202, the radiated signal to/from the internal antenna provides an alternative polarization to that of the external antenna. In this manner, the radiated signal from the wireless communication unit, via both the internal antenna 330 and the external antenna 202, exhibits a moderately elliptical radiation pattern. This increases the likelihood of the receiving antenna (either at the subscriber unit or the BTS) of receiving a transmitted signal. The axial ratio of the ellipse is dependent upon the coupling value of the directional coupler, which in turn is selected based on PA requirements.

Advantageously, by careful selection of the coupling value of the magic-T device as described above, it is possible to provide between 0-dB to 3-dB return loss buffering for the power amplifier (PA). Present day commercial PAs require some isolation from high power signals reflected back from the antenna. This protection ranges from a voltage standing wave ratio (VSWR) of:
(i) 6:1 (equivalent to a RL of 3-dB),
(ii) 10:1 (equivalent to a RL of 1.7-dB), to
(iii) 20:1 (equivalent to a RL of 0.9-dB).

Instead of a purely resistive attenuator, the proposed application substantially allows all the energy to be radiated.

In a further enhanced embodiment of the present invention, a further antenna (second internal chip antenna-2 360) is operably coupled to port-4 of the magic-T. In this manner, any signal reflected due to antenna impedance mismatch, i.e. reflected from the primary antenna 202 back on path 340, is coupled to the second chip antenna element 360 to increase the radiated signal. Preferably, the second internal antenna 360 has the same characteristics and properties as the first internal antenna 330. Furthermore, in such a configuration, the isolation circuit 226 provides increased protection of the transmitter circuit and particularly the power amplifier.

In this reverse direction, let us examine the worst-case performance of a disconnected and thus mismatched antenna 202 where there is a 3 db coupling value. The incident power is distributed evenly, i.e. 50% to port-2 and 50% to port-3. The power at port 3 is radiated, whereas the power reflected from port-2 is reflected. Therefore, 25% of all incident power is reflected to port-4 and radiated by antenna-2 360 and 25% reflected to port-1 and to the PA 224. Thus, in this configuration of two internal antennas, 6-dB isolation of the PA 224 is achieved. The actual effective radiated power depends on the respective efficiencies of the antennas. In this manner, a cost effective solution is provided that enables the transmitter output to be stabilised and removes the need for a large and costly circulator or isolator. The cost saving is approximately 90%. Furthermore, the footprint saving by removing the circulator or isolator is more than 80%. The actual protection from the extra components depends on the insertion loss of the respective components

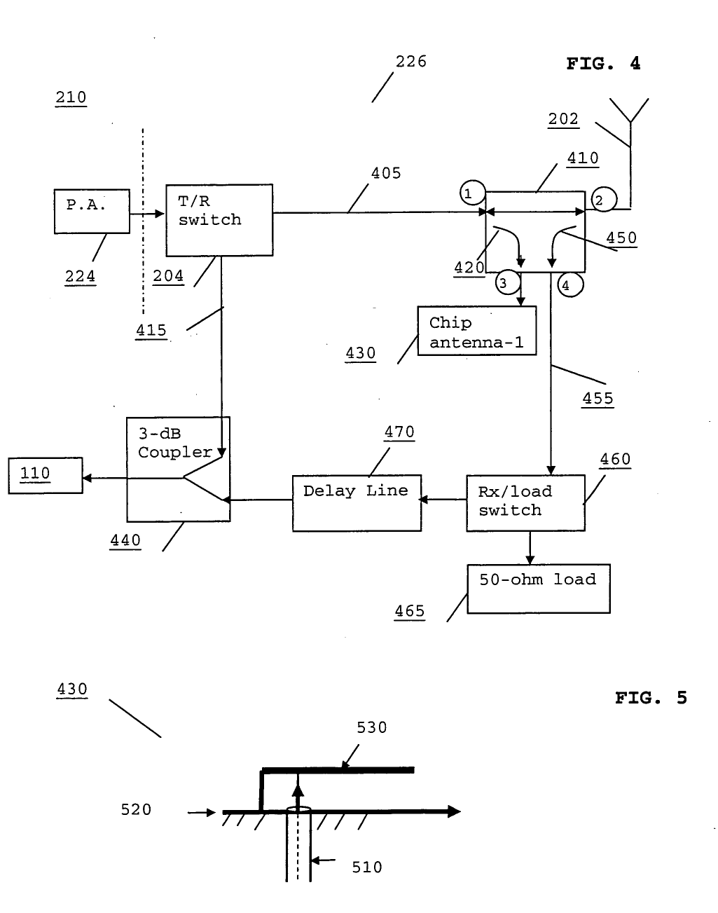

In a yet further embodiment of the present invention, the concept of employing both an external antenna and an internal antenna in the same wireless communication unit is extended to enabling them to function in co-operation as a circular polarization antenna system, as described below with respect to FIG. 4. Advantageously, the topology described in FIG. 4 supports circular polarization in both a transmit and a receive mode of operation of the wireless communication unit.

In a worst-case scenario, the PA isolation provided is 3-dB when the two antennas are disconnected and phased correctly in the reverse mode. In reality, this level of performance is impractical and a typical worst-case isolation is about 5-db return loss (RL). This is based on an assumption that the internal antenna cannot be significantly affected. There will also be some reflected wave cancellation due to out-of-phase components.

Referring now to FIG. 4, the topology for circular polarization for both receive and transmit modes is described. In order to provide a circular polarization arrangement that incorporates transmit isolation that applies to both transmit and receive line-ups, a few additional components are required. Thus, in addition to the preferred magic-T device 410, the following elements are introduced: a receive/load switch 460 and 50-ohm load 465, a 3-dB coupler (typically implemented as Wilkinson splitter) 440 and a delay line 470.

Let us consider a transmit (TX) mode of operation, where the energy output from the power amplifier 224 is passed through a Transmit-Receive (T/R) switch 204. In this mode of operation, the T/R switch 204 is arranged to pass signals (on path 405) from the transmitter circuit and isolate signals from leaking via path 415 to the receiver circuit. The transmit signal is then input to a directional coupler 410, say a 3-dB magic-T coupler, where it is split between two ports (port-1 and port-3).

Notably, the two ports of the directional coupler 410 are arranged to be ninety-degrees out of phase. In this manner, the two antennas 202, 430 are therefore configured to receive and radiate transmit signals that are ninety-degrees out-of-phase. By providing the transmit energy to antennas with different polarization creates a truly circular polarized radiated signal, assuming the energy provided to both antennas is the same. Otherwise, when the radio frequency levels are unequal, the radiated signal results in a substantially circular extending to an elliptical polarized signal.

Advantageously, assuming the antennas are interfered with and detuned, half of the power reflected from the internal PIFA antenna will be reflected to port-1 and the other half dissipated in the 50-ohm load. The same applies to the power reflected from external antenna 202. Assuming a worst-case scenario of a disconnected external antenna 202, and a detuned internal antenna that reflects half of the incident energy, an overall value of the reflected power is:
25%+12.5%=37.5%

This equates to 4.25-dB return loss protection. Signal processor 208 and/or controller 214 perform the control of the signal routing provided by the Receiver/load switch 460.

In a yet further enhanced embodiment of the present invention, an additional chip antenna replaces the 50-ohm load 465, and performs in a similar manner to that described above with respect to FIG. 3.

As described above, a significant benefit of the present invention is the ability to radiate (and receive) signals when another antenna is disconnected, malfunctioning or is mismatched. In this topology, if the external antenna 202 is disconnected, the reflected wave 405 into the power amplifier is 6-db below maximum transmit power, due to the successive 3-dB signal reduction of the reflected signal by port-2 and port-1 of the directional coupler 410.

In a receive (RX) mode of operation, an electromagnetic signal is received at external antenna 202 and internal antenna 360. The energy from both antennas is routed via both receive paths, i.e. a first receive path 405, 415 via T/R switch to the 3-dB coupler and a second receive path 455 via the Rx/load switch 460 and the delay line 470 to the 3-dB coupler 440. These two received signals are summed in the 3-dB coupler 440, and properly phased by the ninety-degree delay line 470.

Advantageously, a very low performance Rx/load switch 460 may be employed as it already includes typically 20-dB of directivity isolation from the directional coupler 410.

Thus, the circular polarization antenna topology of FIG. 4 provides improvement of overall system performance by the use of circular (or substantially circular) polarization in the subscriber device, preferably in addition to its corresponding base transceiver station. Such a subscriber antenna topology finds particular applicability in the private mobile radio market, where the performance of large and expensive system infrastructures is performance limited by the radiating capabilities of a limited number of subscribers devices.

Referring now to FIG. 5, a cross-sectional drawing of an internal antenna 430, for use in the preferred and/or enhanced embodiments of the present invention, is illustrated. The internal antenna is preferably a planar inverted F(-shaped) antenna (PIFA). Such internal antenna designs have been widely used, and the designs may take on many shapes/configurations. However, the basic principle in the design remains the same.

A transmission line such as a coaxial cable 510 feeds the transmit signal to the antenna 430. The transmit signal is fed to a radiating ground plane 520. The radiating ground plane 520 is coupled to a shorted quarter wave or patch transmission element 530. The broad arrows are the main radiators. The main advantage of this antenna 430 is its efficiency despite the small dimensions.

The transmission line structure 530 can be viewed as a coil-shorted section to the left of the feed line (preferably a co-axial cable 510), and a capacitor-to the right. These are resonating at the required frequency and creating a large current (indicated by the small upward arrow) on the feed line 510. This current is the usual feedline current, which is multiplied by the resonant circuit quality factor. Thus, good radiation efficiency is achieved despite the small feedline dimensions. In addition, the imbalance of the currents on the transmission line formed by 530 and 520 is an additional source of radiation (as indicated by the arrow to the right of the feed line 510).

In the preferred embodiment of the present invention, the directional coupler is preferably an integrated on chip 90-degree phase shift magic-T, coupler.

Advantageously, the proposed antenna system topologies both enhance the antenna performance of the wireless communication unit and provide improved isolation for the transmitter's Power Amplifier from antenna impedance variation when in normal use.

Advantageously, the inventive concepts of the present invention provide a significant improvement to the performance of linearised transmitter circuits. However, it is within the contemplation of the invention that the antenna topologies/isolation circuits 226 of the preferred and enhanced embodiments of the present invention may be applied to any radio transmitter circuit.

Furthermore, it is envisaged that integrated circuit manufacturers may utilise the inventive concepts hereinbefore described. For example, it is envisaged that a radio frequency integrated circuit (RFIC) containing the aforementioned circuit arrangements could be manufactured and sold, for incorporating into wireless communication units. In this regard, a RFIC includes an antenna arrangement with an internal (preferably chip) antenna 330, 430, for radiating and/or receiving electromagnetic signals. The internal antenna 330, 430 is located within the RFIC. The RFIC also includes an output port, operably coupled to the internal antenna 330, 430, for outputting a radio frequency signal to an external antenna 202 that can be operably coupled to the RFIC via the output antenna port. Thus, it is envisaged that the external antenna would be located substantially outside of the RFIC, such that both the internal antenna 330, 430 and the external antenna are able to co-operate on radiating or receiving substantially the same electromagnetic signal, as described above.

It is also within the contemplation of the invention that alternative linearisation techniques can benefit from the inventive concepts described herein. When applied to linearised transmitter circuits, the invention is not to be considered as being limited to Cartesian feedback. For example, as an alternative to using Cartesian feedback, a pre-distortion form of lineariser may be adapted to implement the preferred or alternative embodiments of the present invention. Y. Nagata described an example of a suitable pre-distortion transmitter configuration in the1989 IEEE paper titled “Linear Amplification Technique for Digital Mobile Communications”.

It is also within the contemplation of the invention that the wireless subscriber communication units and antenna topologies/isolation circuits described above may be applied to non-transceiver wireless devices. In this regard, for example, it is envisaged that the inventive concepts may be equally applied to broadcast equipment, where the device only transmits, or in paging equipment where the device only receives. Furthermore, it is also envisaged that the inventive concepts described herein are equally applicable to short range communication systems such as BlueTooth™.

It will be understood that the wireless subscriber communication units and antenna topologies/isolation circuits, as described above, provide at least the following advantages:
(i) The antenna topologies are configured to provide both an external antenna and at least one internal antenna to radiate the same signal (or receive the same radiated signal), thereby increasing the antenna efficiency of the wireless communication unit.
(ii) The antenna topologies provide an immediate and simple back up antenna, when one or more of the two or more antennas is disconnected, malfunctioning (for example with a loose connection) or is mismatched.
(iii) The circular polarized embodiment provides the capability in a subscriber unit to radiate and receive circularly polarized signals, thereby improving the overall system performance, particularly when the base transceiver station is able to transmit and receive circularly polarized signals.
(iv) The proposed circuits provide transmitter power amplifier buffering with minimal insertion loss. In this manner, the buffering reduces the power level of any reflected signal, say due to any antenna mismatch, thereby minimizing a risk of self-oscillations in the power amplifier.
(v) In protecting the power amplifier from de-tuning of the antenna or mis-matching of the antenna input impedance, by routing high power signals into other radiating elements, the risk of devices such as the power amplifier overheating are minimized.
(vi) It is possible to provide a linearised transmitter configuration without the need to include a costly and bulky ferrite isolator or circulator.
(vii) The level of isolation is controllable by careful selection of device characteristics.
(viii) In embodiments where two or more internal antennas are used, the power reflected from the external antenna, due to the environment, is not lost but re-radiated by the internal antennas.

Whilst specific, and preferred, implementations of the present invention are described above, it is clear that one skilled in the art could readily apply further variations and modifications of such inventive concepts.

Thus, a wireless communication unit has been described that substantially addresses the problems associated with isolating the power amplifier from the antenna with regard to mismatched reflection of signals, whilst still providing a low loss and low cost solution.

1. A wireless subscriber communication unit comprising:
an antenna arrangement for radiating and/or receiving electromagnetic signals;
a transmitter, operably coupled to said antenna arrangement, for transmitting a radio signal; and/or
a receiver, operably coupled to said antenna arrangement, for receiving a radio signal; wherein the antenna arrangement comprises:
a first antenna; and
a second antenna; and
a directional coupler operably coupled to the first antenna to route a first portion of a signal to and/or from the first antenna via a first communication path and operably coupled to the second antenna to route a second portion of the signal to and/or from the second antenna via a second communication path.

2. A communication unit according to claim 1 wherein the first and second antennas are configured to produce a combined desired transmitted or received signal polarisation.

3. A communication unit according to claim 2 wherein the antennas are configured to transmit or receive signal portions having an identical linear polarisation to produce a combined desired linear polarisation.

4. A communication unit according to claim 2 wherein the antennas are configured to transmit or receive signal portions having different linear polarisations to produce a combined desired elliptical or circular polarisation.

5. A communication unit according to claim 1 wherein the first antenna is an external antenna located substantially outside a body of the unit and the second antenna is an internal antenna located substantially inside the body of the unit.

6. The wireless subscriber communication unit according to claim 1, wherein in operation the first signal portion is either in phase with, or substantlally 90 degrees out of phase with, the second signal portion.

7. The wireless subscriber communication unit according to claim 1, wherein the directional coupler is a four-port device.

8. A wireless subscriber communication unit according to claim 7, wherein said four-port device comprises a magic-T hybrid device.

9. A wireless subscriber communication unit according to claim 7, wherein said transmitter is operably coupled to a first port of said four-port device in operation routing a first portion of a transmit signal to the first antenna via a second port of said four-port device and routing a second portion of the transmit signal to the second antenna via a third port of said four-port device.

10. A wireless subscriber communication unit according to claim 9, including a further antenna, operably coupled to a fourth port of the four-port device, for radiating first portion signals reflected back from the external antenna via the second port.

11. A communication unit according to claim 10 wherein the further antenna comprises an internal antenna.

12. A communication unit according to claim 1 including a transmit-receive switch connected between the directional coupler and the first antenna to enable the first antenna to be used in a transmit mode of operation and alternatively in a receive mode of operation.

13. The wireless subscriber communication unit according to claim 1, further including a transmit-receive switch, wherein said directional coupler and said internal antenna are operably located between said transmit-receive switch and said external antenna to enable both the first antenna and the second antenna to be used in both a transmit mode of operation and alternatively in a receive mode operation.

14. A wireless subscriber communication unit according to claim 13, including a second coupler operably coupled to said directional coupler via said transmit-receive switch in a first receive path and operably coupled to said directional coupler via a transmission delay means in a second receive path, such that when an electromagnetic signal is received at said first antenna and/or said second antenna it is routed via said first and second receive paths for combining in said second coupler.

15. A wireless subscriber communication unit according to claim 14, wherein said transmission delay means provides in operation phase equalisation to substantially out-of-phase signals at said second coupler via said first receive path and said second receive path.

16. A wireless subscriber communication unit according to claim 15, wherein said transmission delay means comprises a substantially quarter wave length transmission line.

17. A wireless subscriber communication unit according to any one of claims 14, further including a second controllable switch being located between said transmission delay means and said directional coupler on said second receive path to a route signals from said internal antenna and said external antenna to a receiver in a receive mode of operation and isolate said receiver from said antennas when in a transmit mode of operation.

18. A wireless subscriber communication unit according to any one of claim 17, further characterised by a matched load or a further antenna operably coupled to said second controllable switch for receiving signals reflected from said internal antenna or said external antenna when in a transmit mode of operation.

19. A wireless subscriber communication unit according to claim 1, wherein said transmitter transmitter comprises a linearised transmitter circuit.

20. A wireless subscriber communication unit according to claim 1, wherein said unit is capable of operation according to TETRA communication standards.
